(19) United States
(12) Patent Application Publication
(10) Pub. No.: US 2016/0016363 A1
(43) Pub. Date: Jan. 21, 2016

(54) 3D PRINTER AND GESTURE BASED INTUITIVE HUMAN INTERFACES FOR DESIGN OF VEHICLES AND OTHER OBJECTS

(71) Applicant: PSTP Technologies, LLC, Sylvania, OH (US)

(72) Inventors: Peter H. Smith, Ann Arbor, MI (US); Timothy R. Pryor, Sylvania, OH (US)

(21) Appl. No.: 14/728,472

(22) Filed: Jun. 2, 2015

Related U.S. Application Data
(60) Provisional application No. 62/006,925, filed on Jun. 3, 2014.

(51) Int. Cl. B29C 67/00; G05B 19/4099; G06F 3/01

(52) U.S. Cl. CPC B29C 67/0088; G06F 3/017; G05B 19/4099; G05B 2219/35134; B33Y 50/02

(57) ABSTRACT

The invention concerns new computer aided methods and apparatus for designing objects, particularly 3D objects, and especially those having a sculpted form such as found in automobiles, boats, planes, furniture and certain fashion apparel items. Preferred embodiments employ optical sensing, of the designers' hands, fingers, or styling implements, as well as other sensors such as gyros accelerometers and the like as desired. The invention utilizes a specialized form of 3-D printing which produces data incorporating intermediate models for use in the design process. The invention we feel can enable a much larger segment of the population to design 3D objects as well as encourage a high degree of collaboration via the internet or other means.

### BENEFIT CLAIMED

This application claims benefit of U.S. Provisional Application 62/006,925 filed Jun. 3, 2014 entitled “3D Printer and Gesture based Intuitive Human Interfaces for Design of Vehicles and other Sculpted Objects”

### CROSS REFERENCES TO RELATED APPLICATIONS

none

### FEDERALLY SPONSORED R AND D STATEMENT

Not applicable

### MICROFICHE APPENDIX

Not applicable

### FIELD OF THE INVENTION

The Invention herein concerns methods and apparatus for design of 3D objects using movements of human body parts such as fingers or hands, or objects held in the hand such as a stylus. The use 3D printing to create intermediate objects useful in the design process is also disclosed.

### BACKGROUND OF THE INVENTION

Today, the initial design of vehicles for the motoring public is largely undertaken in “Styling Studios”. There, conceptual 3D perspective renderings of a vehicle are made and then, after suitable approvals, brought to life by one of two methods. The first is the time honored and still prevalent construction of models, first in small scale, and then after more approvals full size. These are the famous “Clay Bodies” of automotive lore.

Increasingly computer based styling programs such as “ALIAS” to render images are used to create first designs (based on initial hand sketches), which after approvals are used to mill the initial clay model(s) which is then hand finished. This has made major advancements in design cost and time reduction, but requires a high degree of training which greatly limits participation in the design process

This invention, together with our previous inventions U.S. Pat. No. 702,440 “Man-Machine Interfaces” and U.S. Pat. No. 7,079,114 “Interactive Methods for Design of Automobiles, are aimed at facilitating design of objects including those made possible by 3-D Printing (aka Rapid prototyping, or stereo lithography). The foregoing patents are incorporated by reference herein in their entirety.

The invention addresses among other things
Creation of intermediate 3D printed objects to aid the input of design information resulting in a final object to be printed or otherwise manufactured
Simple tools, which also may be 3D printed optionally as well in conjunction with the object design data file in question to allow assembly or design of organic shapes
3D Printing techniques which may include target landmarks to aid gesture type inputs with respect to the printed object and its orientations.
3D printed mesh data incorporated by the printer directly on the object printed in order that they may be used by the designer interface.
Re-printing of a skin including where desired target or mesh data on top of a previously printed or otherwise manufactured object. This reprinted skin may include modifications made in previous design iterations
The 3D printing of objects with attachment points to attach newly 3D printed portions of a vehicle for example (e.g. A fender), to an existing structure such as a body structure which may hold other portions (such as hoods, body sides etc.)
Robust 3D sensing methods and apparatus for use with 3D design systems
Additional improvements in ease of design, particularly of sculpted objects, as one might chose to do in the home or workshop.

### INTRODUCTION

Recently the subject of 3-D printing has been attracting wide attention and is thought at least a potential breakthrough in the ability of many persons to be able to design and make objects. One of the key assumptions in the breakthrough calculation is that a huge increase in the number of people able to design objects will take place. If such breakthroughs occur it could mean a major improvement in standard of living

A central problem with the assumption was pointed out in the referenced patent applications of the inventors. Namely, the usual interfaces for 3-D CAD systems (for example that of Autodesk company's AutoCAD or CATIA by Dassault Systemes) and others do not easily and intuitively allow the design of Three dimensional solid objects. Successful use of these programs requires extreme levels of training and skill much of due to the necessity of dealing with a two D system (mouse, screen) to create 3D information.

Others have also begun to recognize the problem. For example it was treated recently on CNBC by the commentator Jon Fortt. We feel the answer to this problem is made possible by camera based gestures for lack of a better word and associated disclosures herein along with those of the referenced patents above

We believe that it is in turn the difficulty in handling 3D designs that limits the marketplace for 3D printers. Paradoxically, we feel that the solution proposed herein involves these very same devices. Not only that, but that our methodology opens up a new market for 3D printers as part of a design and collaboration interface. This opens up design to managers, non-technical artists, hobbyists, biologists, plastic surgeons, chemists, planners of all types, crime scene investigators, teachers, etc. Indeed, a 3D printer can be more than a manufacturing device, it can be a key component used as part of an interface for people to develop, design, understand, collaborate, store and transmit ideas related to complex real world geometries.

It is a goal of the invention to illustrate the use of a 3D printer to enhance the interface of design programs, in particular for sculpted surfaces and in conjunction with gestural type inputs of fingers and hands, or objects such as styli held in the hand.

It is a further goal to provide method and apparatus for 3D printing initial and/or intermediate models of objects which can be used as references for human hand and finger and held object manipulation of 3D graphics leading to a final object definition and file

It is an additional goal of the invention to provide a method for creating 3D models which have optically sensed landmarks, optionally including grids or other mesh arrangements which can be used for human interaction with a printed model data base.

It is a goal of the invention to provide 3D printed models with known attachment points for optically sensed target landmarks, which may be of a standard variety, or specially printed for the object.

It is a further goal of the invention to provide method and apparatus to create special tools to aid the human interaction with a model object and in turn with a 3D data file

The realization of these and other goals of the invention are now described

### EMBODIMENTS OF THE INVENTION

The invention is described in the following figures

FIG. 1 illustrates a basic embodiment of the invention employing a 3D printer as part of the human gestural interface, in this case employed for design of car bodies and panels

FIG. 2 illustrates a control panel of the invention

FIG. 3 illustrates a collaboration system of the invention with participants having work stations and 3D printers of the invention as well as an internet connection to each other (and perhaps to some central data base)

FIG. 4 illustrates a mesh and tool embodiment of the invention

FIG. 5 illustrates another tool embodiment of the invention for vector designation and other purposes

FIG. 6 illustrates a medical application of the invention

FIG. 7 illustrates iteration steps of the invention

FIG. 8 illustrates 3D printing of model assemblies and methods therefore

FIG. 9 illustrates a targeted tool whose point is determined from either consideration of targets on the pointer, or from observation of the tool tip directly (where not obscured

### DESCRIPTION OF DRAWINGS

FIG. 1 shows a design object 101, in this case a 3D printed model of a car. At least a portion of the users hand and at least a portion of the car are in front of one or more cameras whose data is processed by a computer that stores and processes the results. To assist the camera(s) in determining the position and orientation of the finger of the user in up to 6 axes, an optional target on the fingernail 130 and another target 132 further up the finger of the user are used in this example.

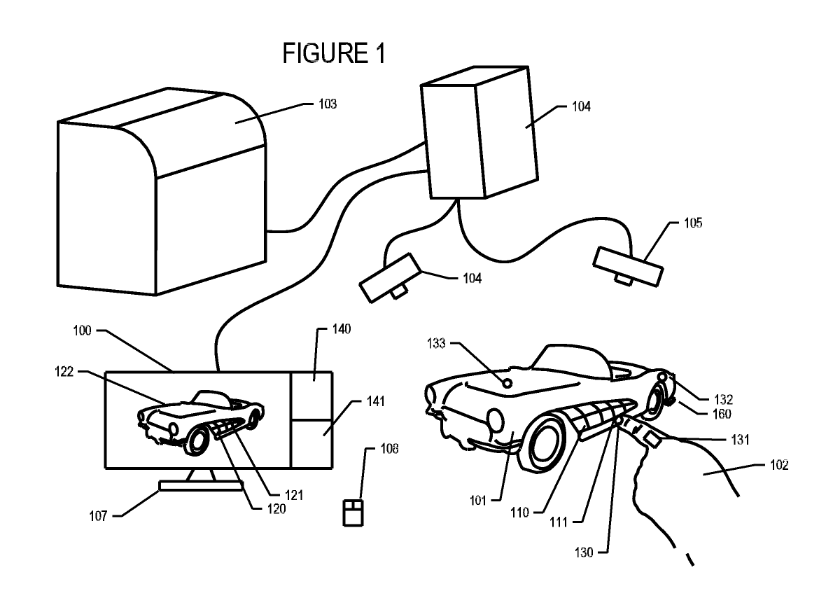

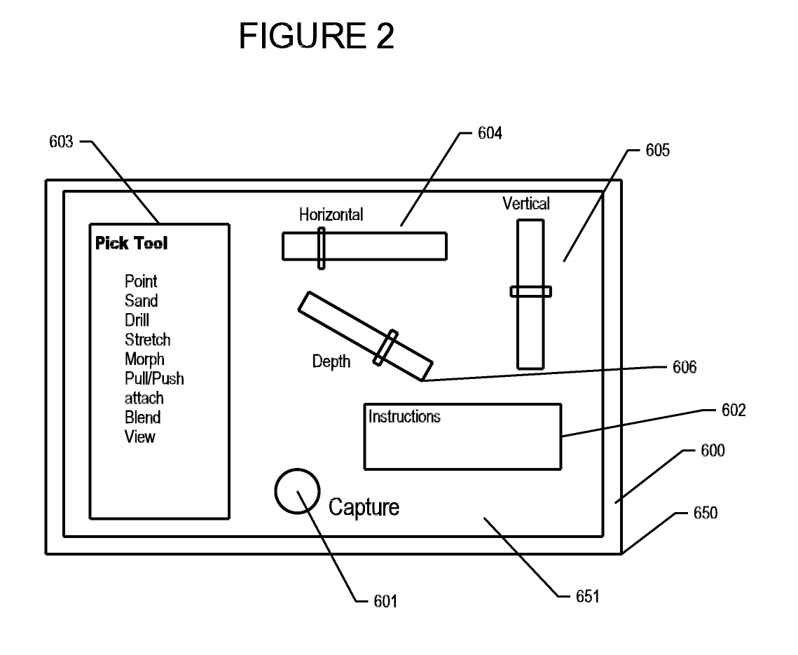

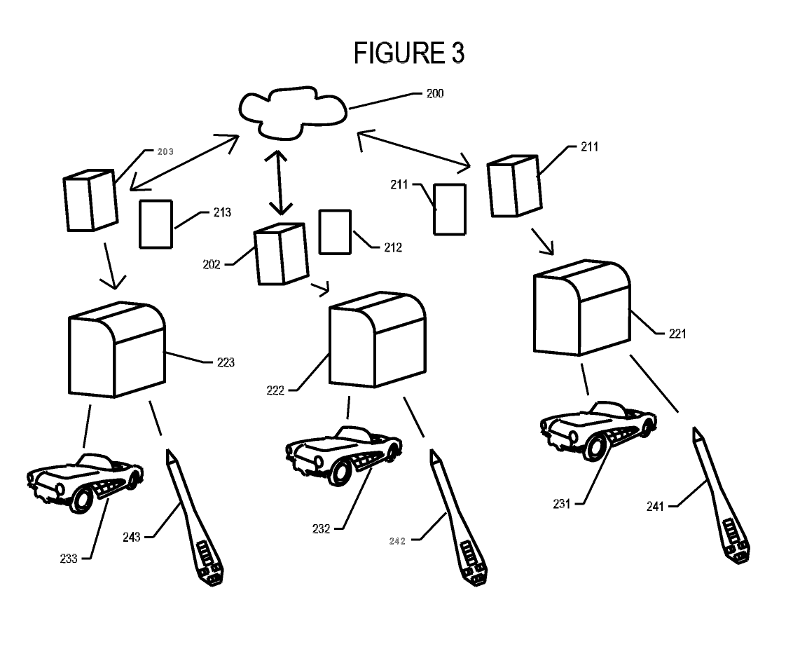

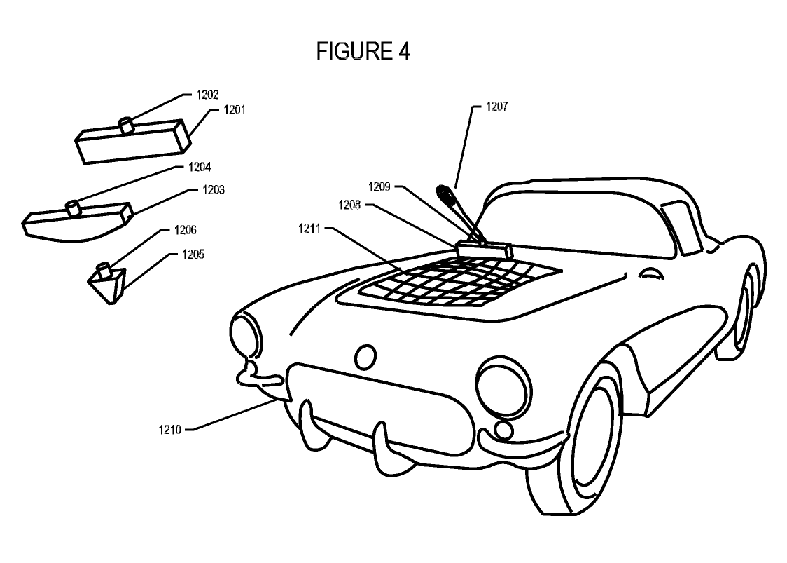

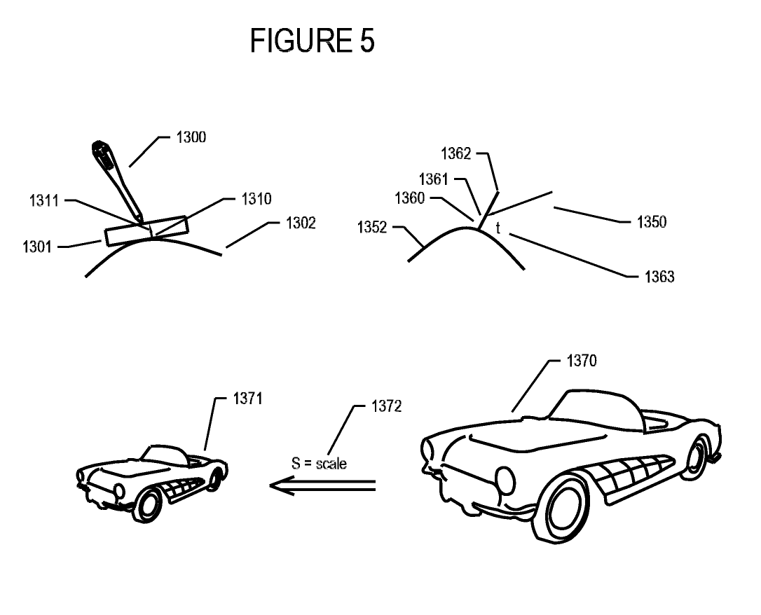

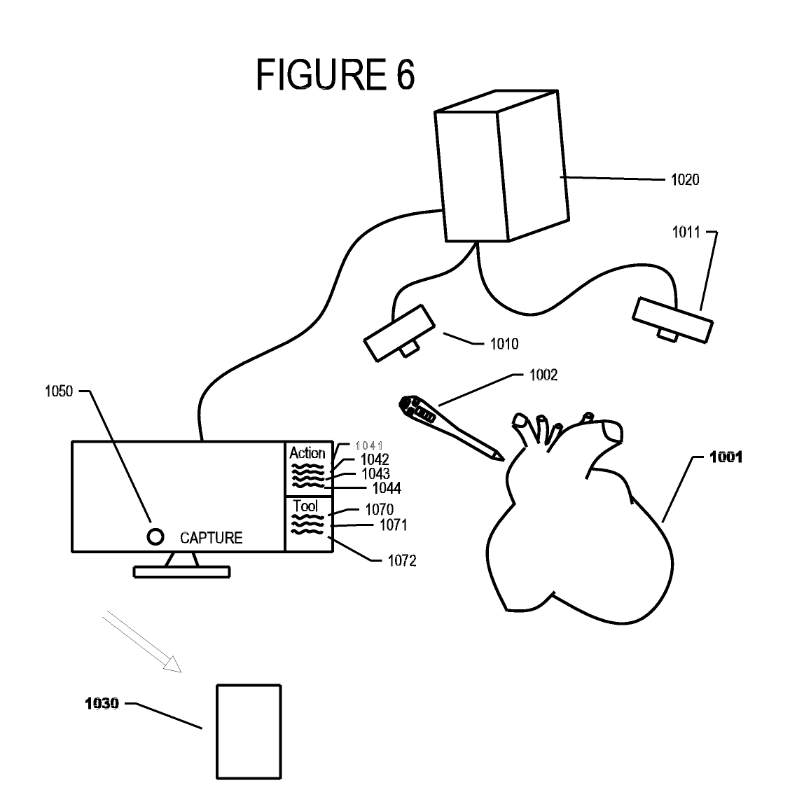

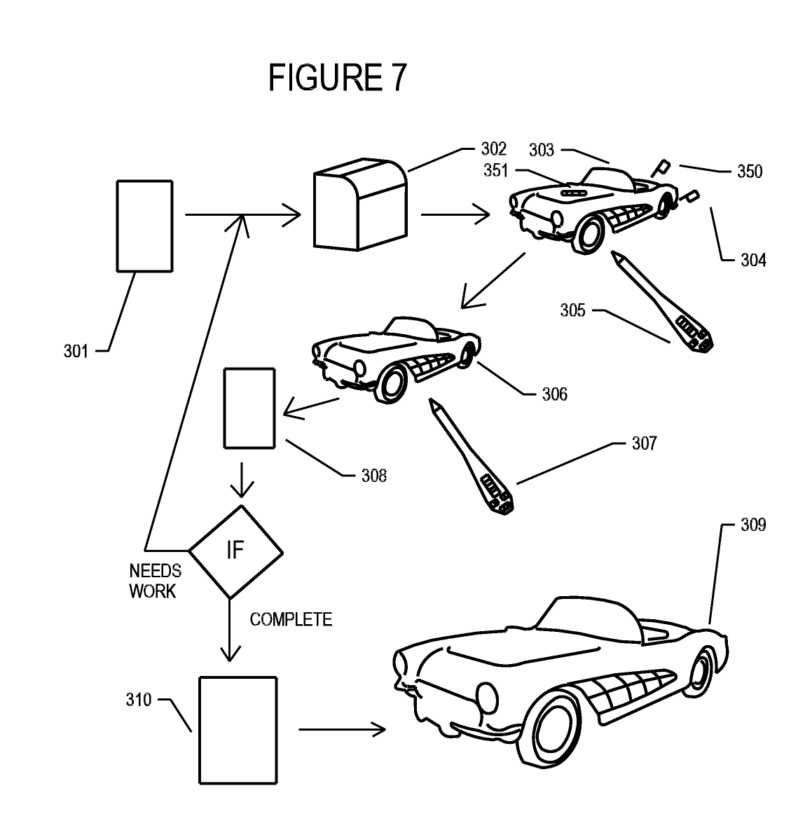

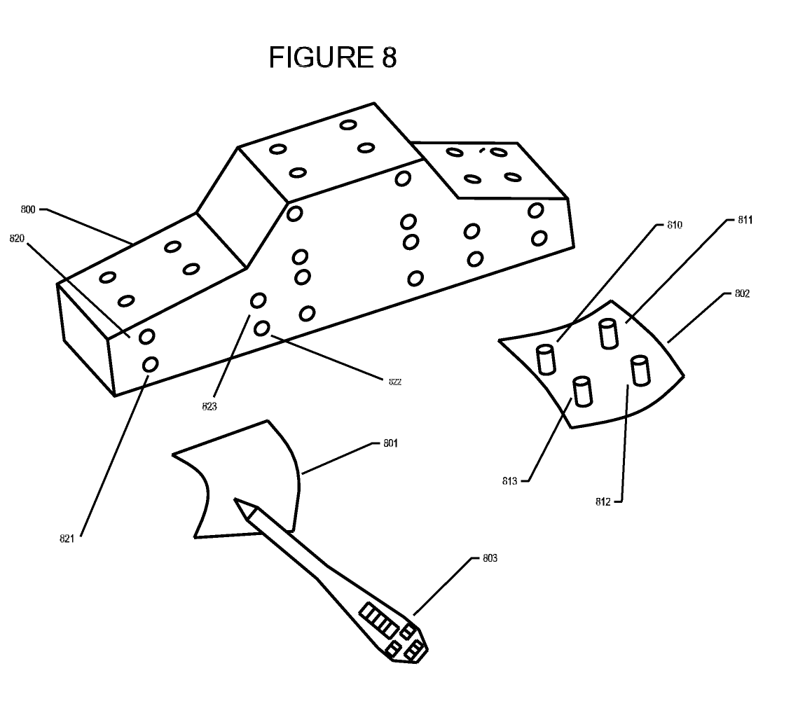

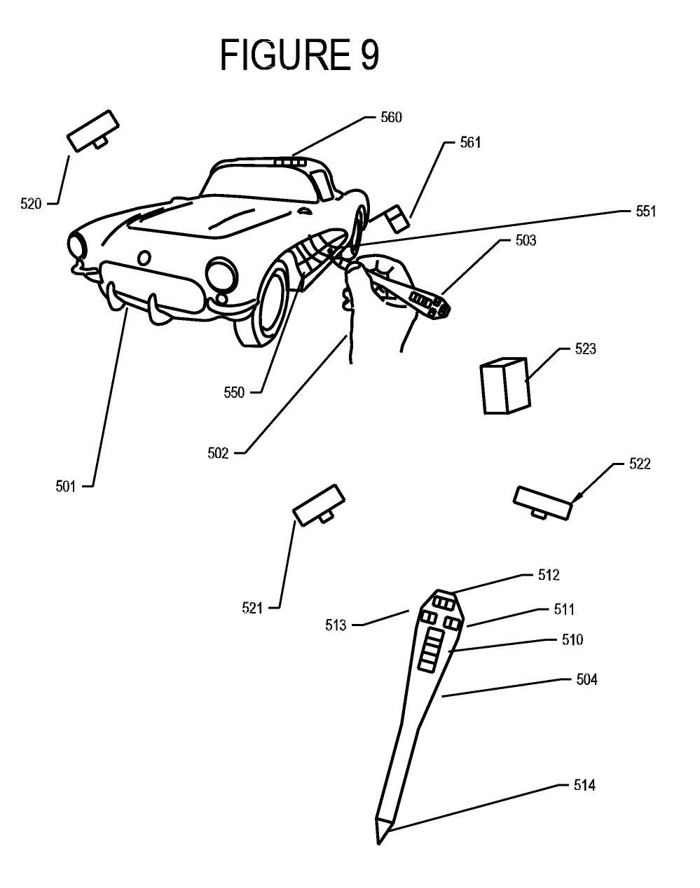

Both the 3D printed model car 101 and the targets 131 and 132 on the user finger can be printed in a 3-D printer 103 along with various markings such as the spline mesh 110 on the models side and targets 133 and 132. The mesh is being touched by the user's finger in this example at 111. The markers, targets and CAD features can using the invention be 3D printed into the surface of the printed model.

In addition, or alternatively, the model can be 3D printed to include mounts 160 for detachable targets, if desired for improved 3D sensing accuracy. One or more electro-optical sensing systems such as 106 and 105, which can for example be 3D sensing types such stereo camera systems or Intel's RealSense can transfer data (via cable or wirelessly) to a computer 104 to determine as required the 3D relative locations and/or orientations of targets, model features and markings, pointers, and model parts. These results can be sent to the design computer 107 running the user design software and used for commands, or data to manipulate the 3D data file. In this case the 3D software is a CAD system (such as CATIA by Dassault Systemes) with a display 100 showing the CAD model 122 to be modified with the spline mesh of the CAD file 120 and the cursor position taken from the position of the user finger 111 on the mesh of the mode, corresponding to display cursor 121.

Note that in addition to the interface of the invention, the CAD system can be run normally driven by the 2D mouse 108 and using the traditional interface commands shown on screen areas 140 and data 141.

FIG. 2 illustrates some of the elements that might make up the interface 600 for the invention. In this example the interface is on tablet computer 650 but this could a typical computer with a display and communication capability. A button 601 is displayed on the screen 651. Each time that the user is satisfied that the tool, pointer, or finger is located and oriented as desired, he may use in this example his other hand to touch the button on the interface. Alternatively he could hold a button in has hand, give a voice command sensed by voice recognition in the computer or some other means

A set of optional methods 603 to modify the 3D model is listed on the tablet display 651 and the user can touch the choice of design functionality she wants to implement. The size and shape or other data that define the tools effect on the 3D model are shown as sliders 604, 605 and 606. Data and instructions can be displayed 602.

FIG. 3 illustrates use of the invention to collaboratively manage a design. Because the interface is natural and involves familiar processes like pointing, sanding, drilling, and making shapes in a sandbox, the decision makers and not just the CAD specialists can make meaningful design input. The cloud 200 can be consider as a transfer hub for three computer based centers 201 for a manager in Detroit, 202 for an artist in Turin, and 203 for an engineer in California. Data files 211, 212, and 213 are shared among the participants. The shared files can include files that can be sent to each 3D printer 221, 222, and 223 to produce identical 3D models 231, 232, and 233 and optionally, identical tools 241, 242, and 243 to manipulate the interface. Note that the relative location and orientation of each tool can be recorded and shared also.

FIG. 4 illustrates how various tools can be attached to the pointer to give the user a feel as to how the action of the tool may modify the model. Tool tips 1201, 1203, and 1205 all are of different sizes and shapes. 1201 and 1203 are built out of spongy material. Both illustrate the use of the tool as a sander. This sander tool can act like the real world tool that removes surface material (equivalent to lower the mesh surface in the CAD database description) and averaging the surface normals under the sander. However, this being software, we can choose the weighting of each (the location change and the surface normal change) as a function of the height of the tool above the surface. We can even add material (ie. raise the mesh) as we move the pointer off the surface. The attachment collars 1202, 1204, 1206, and 1209 can be hinged (or gimbaled or attached with springy materials) to follow the surface or rigid to act as a cutting tool (or alternatively an addition tool). Such a tool 1207 with a spongy tip 1208 and hinged collar 1209 is shown over a mesh 1211 on a model 1210

FIG. 5 illustrates the typical math used implement this method in a software program. The physical world pointer 1300 can be represented by a vector in the CAD model 1350 having its vector head 1361 at a relative location equivalent to the pointer tip 1311 over the 3D print model. The orientation of the pointer shaft relative to the 3D print model is the same as the vector to the CAD model after passing through a 3D mapping process. Usually the mapping is nothing more than a uniform scaling in all 3 dimensions. However, more complex mappings can be developed that scale or otherwise transform locations and orientations of the 3D model to that of the CAD model. We can use printed points or features on 3D print model to calibrate an error correction mapping. If there is any systematic error in the 3D tracking, the location and orientation can be improved using this non-uniform map.

The tip attachment is shown as 1305 attached to pointer 1303 that has a tip 1304 can be represented as a vector 130 can have targets that track its location and orientation. Or that location and orientation of the tip relative to the target can be used together with the CAD geometry to determine the location and orientation of surface normal that would intersect the vector representing the tool

1302 represents the local surface normal.

FIG. 6 Illustrates how the invention may be used to record details of potential surgery paths which a surgeon user might undertake. Some steps using the invention are
Create a 3D print file from a CAT scan or other scan of a patient's heart.
Split the file into parts that can be taken apart allowing the pointer to move around the interior of the heart.
Use a 3D printer to print the set of parts that make up the heart model 1001.
Move the pointer 1002 to significant points along the heart, identify a surgical tool and surgical action to be used in the tablet interface 1080 by touching the action 1041, 1042, 1043, or 1044.
Likewise choose the surgical tool 1070, 1071, or 1072.
Hit the record button to have the cameras capture the heart and pointer locations and orientations.
Store the tool tip location and the tool orientation in computer 1020 along with the surgical tool ID and surgical step information. This surgical path file 1030 storage could be used later for training or document the operation.

This same path file idea could be used to undo a design mistake when using the invention for 3D model modification.

FIG. 7 illustrates how natural tracking together with 3D printing could be used iteratively to achieve an elegant design. The initial design 301 could from a 3D scan of an inspirational object or an online library or a CAD model. The design is then created by a 3D printer 302. The pointing tools 305 needed for the design task and attachable targets 304 could be printed along with the design object 303 if they are not available from previous work. The design object could desirably, but not necessarily, include targets 350 and CAD markings such as mesh 351.

The user then moves the tool 306 relative to the model and this sends instructions to the software program telling it how to modify the software based model. This process continue until the user is satisfied with the design modifications or until the design is so different from the 3D print that a new modified print is desired. At this point the modified design is stored in a design file 308. If the design needs more refinement, repeat the process starting with a new 3D print based on the latest design file. Else send the data to the next stage of product development and if desired create a real world car without targets or marks scaled as desired.

FIG. 8 shows the how a design could be developed by an assemblage of parts. In this case we 3D print a base figure with attachment elements such as the dowel holes shown in the figure as 820, 821, 822, and 823 or slides etc. A fender 801 is shown being modified with a tool 803. The underside of the fender has dowels that mate with the holes in the base. Dowel 810 slips into hole 820. Dowel 811 slips into hole 821. Dowel 812 slips into hole 822. Dowel 813 slips into hole 823. One advantage of dealing with parts is that the design parts can be scaled up or down to be a convenient size to handle in modeling and then scaled again to work as a complete entity. It also makes it easy to put together a set of library parts (such as a Ferrari front together with a Corvette rear and an Audi Passenger compartment). This setup is useful to experiment with different designs manifested as real 3D object models, storing the modified surface files for possible use in the future. The attachments 810, 811, 812, 813 could also be used to hold the 3D print object precisely for material removal by a CNC tool.

FIG. 9 illustrates how a tool such as a pointer could be used to manipulate the CAD model that has a spline surface mesh printed on it by the 3D printer or other means. The user of the CAD system identifies the elements of the model (such the surface mesh on the car's hood) that he is having difficulty modifying using the traditional 2D mouse or tablet. She might wish to carve a smooth channel on the fender along a 3D path that doesn't follow easily described mathematical relationships typically used in CAD modeling such as perpendicularity, parallel, sweeps, cylinders etc. The tools built into CAD systems have great difficulty modeling natural organic shapes. CAD systems rely on these mathematical relationships to define 3D location of spline knots and the orientation of surface normals. It is hard enough to teach your brain to understand how to define a 3D location using a 21) mouse or tablet and check your result on a 2D display that for accurate math display usually removes the parallax built in to our eyes natural stereo viewing. As if that isn't bad enough, you also need to define the surface normals (perpendicular to the surface) all with 2D tools.

FIG. 9 provides additional illustration of how a car model 501 can be sensed by an electro-optical sensor based tracking system to produce an interface. The car model in this example has several targets that are part of the model itself or can be attached at precise positions that are 3D Printed into the car model. A target on a surface is shown as 560 on the surface of the car. In this example, another target 561 is hanging off the side

Similar to the target on the surface, on the side of the car is a 3D printed mesh 550 with a surface normal 551 at the pointer tip. The mesh is shown more completely in previous examples. The pointer 503 is held in the user's hand 502. Cameras 520, 521, and 522 can track the location of tools and the car model and send data to computer 523 which can compute the relative 3D locations and orientations of the tools with respect to the car model. As noted previously, target datum on the objects and tools can optionally improve both the accuracy and speed of location, and in some cases further aid the human in understanding the action of the system. Trouble shooting is easier as well. Pointer 504 illustrates some examples of targets that might be on a pointer. 514 is a colored tip, 510 a planar target, and targets 511, 512, 513 are placed on a set of 3D facets.

Object or tool sensing systems not employing targets can also be provided, using three Dimension object and/or tool information at large numbers of points to for example match a model to the object, and thus determine from the matching procedure the location and orientation of the object. Combination systems such as with one target and a matching program or other suitable machine vision software can also be utilized.

The pointer 505 the tip of the pointer and the targets of the pointer define both a position in three dimensions and a vector direction can be applied to the mesh. As the pointer moves in or out it can push that mesh point in or out along the vector direction indicated as 551. The target itself can have multiple target facets that can be seen by multiple cameras. The pointers shown more completely on the side is 504 with a tip of 514 have you target and several targets of different types and shapes going from 510-513.

It is noted that a 3D Printer can have electro-optical sensors incorporated which can look at a previously printed object, and if material issues permit, register optically (or otherwise) the object and print on an object at a further time with a skin or overlay of material. This skin could include not only design changes but mesh and targets as described above

The invention aids 3D relative to object for teaching, planning (surgery), defining for collaboration. Writing is difficult to describe tasks that have to be done in 3D. In a 3D database, one may store associative data along with a 3D printer file and any 3D path with respect to the object in the printer file and station points along the path where different tasks are performed.

One can print a tool that can be used in three-dimensional CAD design or for the development of a sculpted organic 3D shape the tool has ended markers that can be seen by multiple cameras to define its location and orientation in three dimensions relative to an object that is also 3-D printed that has markers in it also so the two objects can be determined in three dimensions relative to each other. The markers can be removed for the final print

The design process can be accomplished in an iterative way so that the first object is printed and then a 3-D tool can be put next to it to define the CAD manipulation to modify the shape. And then the shape it can be printed again in another pass and be made from this new shape such as a stretching or a bending or other type of modification

A collaborative project can be developed from the same file where not only is a database forms containing documents and drawings and kids files but also three-dimensional print files of the object that is being used.

Define 3-D Pass the path might be for a robotic path that can be used to record the emotions of strokes that were used in the 3-D design process can be used to capture plans for surgery can be used for training and used to collaborate with people at a great distance. You can store and object in 3-D that you're trying to move around or design or interact with and some pushing you can store The 3D pointer or method that you're offsetting from the object and you can store with 3-D XYZ coordinates of your path

The pointer tool can be used to create an assemblage of a set of parts. For example, we could have a group of noses eyes and head lips eyes, much like the game “Mr. Potato Head”. One can then point the pointer on the object at the location where these body parts were supposed to be, and stretch along it to make a larger smaller base for the nose which would have been the impact of stretching the nose longer or make it smaller than you could turn to the side and move the pointer tip closer towards the head tube to make the no smaller you could you actually even move the pointer tips Riviere and capture a profile of the nose. The nose could be then sculpted to fair into the face better using the pointer tip to not only give the location of where the shape should be modified but also give a normal direction of the smoothing tool that might be used the tool itself you point to something on the screen of your year of your computing screen computing devices screen to see better what you're looking at.

You could also use the location of the pointer tip along with the general direction from the target on the back to the tip would be to define a vector that could be used as both a camera location and orientation as you move the pointer around it could define the point of view that you're looking at the CAD file or the design object on a computer display

The invention allows intuitive design either the design of objects (and the tools used to interact with the objects where desired) or the modification of existing designs or objects which may be obtained from internet downloads, scanning or the like. The invention further provides a unique ability to use the 3D printing process itself to aid the design, by providing intermediate physical reference objects, including those with target landmarks capable of aiding the camera interface system to orient and position the object for input, and physical meshes printed directly on the object in reference to its data base

The invention aids the design of organic shapes and the blending of organic shapes for example those that might be used in medicine by plastic surgeons to simulate the effects of particular operations. Another application is in the automobile business for various shape parts of vehicles and the incorporation of compliments that have shaped surfaces. This also includes the assembly of such compliments. The invention also can aid other assembly applications.

Modern CAD systems are powerful, elegant tools that can produce splendid designs of cars and other objects and software developers continue to add new features that can produce more and more elegant designs. The issue we address is that this means there is more to learn and master. We do not want to make design software; we want to make design software easier.

The disclosed methods allow the CAD system to be controlled in a natural way using techniques humans have learned every day of their lives. This obviates the present need to have years of schooling and work experience to produce a reasonable model; and the worry that interface changes and memory lapses will make one incompetent after a few years away from the trade.

Tool can be something you hold (shown in Design of Automobiles patent and present) or something on end of a finger, as shown in previous work

Points on object and/or tool 3D printed to facilitate detection of position and or orientation of the object or the tool. Print can be contrasting color. Different points can be coded with color, or shape or arrangement of printed target landmark. Tool shapes can be printed especially for a particular task and even relative to a specific model or iteration of a model. Or standard shapes with known characteristics can be used.

Appendages can be 3D printed on the object or tool to act as targets or to facilitate the use of a target. Similarly, attachment points such as dowel holes, slots etc. can be 3D printed to allow the subsequent attachment of either standardized targets or especially 3D printed targets

Tools or objects can have added sensing capability with attachment of Gyros, Accelerometers and the like. Data from these can supplement the electro-optically sensed data and in some cases be used instead (for example when obscurations occur of the optical paths. These sensing devices can optionally be attached using 3D printed attachment points

The invention optionally allows physically present Mesh points when desired to be printed directly on the 3D printed object. These points can be typically high contrast and can be colored also to allow identification one from the other. These points can be sensed by the electro-optical sensor system and the contact with the points by the user tool or body part registered.

Also we have disclosed a method of iterative 3D printing wherein the same model is put back in the printer after suitable registration (which can include electro optical sensor system such as one or more cameras in the 3D printer) and a new additive layer printed on the model, further including printing a changed mesh and/or targets where applicable

A further method of printing where a model is made in larger than final size and material removed for example with a mill as part of the design process and upon direction of the user.

And then where desired an additive re print of a top layer made. The new top layer can include targets and/or a mesh (noting that the mesh points can also act as targets for orientation and position as well)

The invention contemplates that one can 3D print iterative design objects with targets as desired, which may be on the surface of the object, or an appendage thereto. The targets can be reflective, black or white and/or of given shape and colors. The targets can be used as previously disclosed to identify an object, combining geometry with simple database data. This data may for example, be derived from a color code if the 3D printer to be used is capable of color printing. Object location and orientation to a finger or stylus can be obtained by extensive processing of sensed 3D images themselves such as those obtained using an INTEL RealSense product. However, employing one or more targets on the object and or finger or stylus is often advantageous in that it always in the right spot, part of a single rigid body, nothing to get lost, optionally identifies object as well as side of object. 3D location and orientation in up to 6 axes can be readily obtained using laptop computer for example from the targets as well which is important for ease of use which is desirably real-time, with minimum latency of movement of the human with respect to the object. One can link a database to object that define surfaces and other geometric data. Database can define physical attributes, videos, linkages, and assembly data. This can be extremely important for organic shapes such as medical data for where to cut surgically. Having the ID incorporated with the object means that you can scan ID and call up database info. One can also store 3D paths that go with an object i.e. planned surgical procedure such as develop and reproduce path for robotic moves if employed.

Modifications of the invention herein disclosed will occur to persons skilled in the art, and all such modifications are deemed to be within the scope of the invention as defined by the appended claims.

1. A method for creating an object data file comprising the steps of
Providing a computer
Providing a 3D printer
Providing a sensor interfaced to said computer for sensing a user controlled member
Providing an initial object data file in said computer
Using said initial data file, printing an intermediate 3D object using said printer
Using said sensor and computer, sensing said user member indicating changes desired in said intermediate object representing the initial data file
Using said sensed changes, modifying the initial data file in said computer; and
Creating an object data file from said modified initial data file

2. A method according to claim 1 wherein said user controlled member is a user body portion

3. A method according to claim 2 wherein said body portion is comprised by at least one finger

4. A method according to claim 2 wherein said body portion is moved in a gesture

5. A method according to claim 1 wherein user controlled member is held in the users hand

6. A method according to claim 1 wherein said Initial data file is downloaded to said computer

7. A method according to claim 1 wherein said initial data file is created using said sensing mans

8. A method according to claim 1 wherein said initial data file is created by scanning a first object

9. A method according to claim 1 including the further step of creating a final object from said object data file

10. A method according to claim 1 including the use of a sequential plurality of changed intermediate objects

11. A method according to claim 1 wherein said sensor is a non-contact sensor

12. A method according to claim 11 wherein said sensor is a non-contact sensor

13. A method according to claim 1 including the further step of using said printer to produce said member

14. A method according to claim 1 including the further step of using said printer to produce targets or other landmarks which may be attached to said intermediate object

15. A method according to claim 1 including the further step of sensing features on said intermediate object

16. A method according to claim 1 including the further step of printing features on said object which are subsequently sensed

17. A method according to claim 1 wherein the relative location of said object in the printer and the 3D body portion or member is sensed and used by said computer to modify data file

18. A system for creating an object data file comprising
A computer
A 3-D printer controlled by said computer
A non-contact sensor interfaced to said computer and sensing a body portion of a user or an object moved by a user with respect to a 3-D printed object

19. A system according to claim 18 wherein said sensor is located within said 3D printer

20. A system according to claim 18 wherein said sensor further senses information from an object printed by said 3D printer.
